(19) United States
(12) Patent Application Publication
(10) Pub. No.: US 2009/0240177 A1
(43) Pub. Date: Sep. 24, 2009

(54) Message device with pressure dispersing edge

(76) Inventor: Thomas Sullivan, New York, NY (US)

Correspondence Address: BACON & THOMAS, PLLC, 625 SLATERS LANE, FOURTH FLOOR, ALEXANDRIA, VA, 22314-1176, US

(21) Appl. No.: 12/076,586

(22) Filed: Mar. 20, 2008

(51) Int. Cl. A61H 7/00; A61H 9/00

(52) U.S. Cl. 601/136; 601/134; 601/135; 601/159

(57) ABSTRACT

A preventive and/or therapeutic massage device having a fine contact edge and a pressure dispersing edge to provide alternative modes of stretching to the skin, muscles, fascia, and/or tendons of a user. The massage device includes a main body portion with first and second opposed surfaces defined between lower and upper portions and first and second ends. An upper handle portion is formed between the first and second opposed surfaces along the upper portion of the main body. The fine contact edge is formed along the lower portion of the main body and the pressure dispersing edge extends from the first opposed surface. The fine contact edge is used to provide an aggressive, deep stretch, while use of the fine contact edge in combination with the pressure dispersing edge provides a gentle stretch.

### FIELD OF THE INVENTION

The present invention relates generally to massage devices, and more particularly to a preventive and/or therapeutic massage device having a fine contact edge and a pressure dispersing edge to provide alternative modes of stretching to body tissues, such as skin, muscles, fascia, and/or tendons of a user.

### BACKGROUND

The use of instrument assisted massage or soft tissue work to treat muscle injuries has existed in some form for roughly 5,000 years. In particular, ancient Chinese practitioners utilized tools to assist with tissue therapy. Such tools are typically carved out of jade stone or out of an animal horn. These tools are used by a doctor or acupuncturist to treat injuries by scraping a tool over tight muscles (also referred to as trigger points).

Recently, tools having a similar structure and function as these prior tools were developed. These more recent tools have been formed from stainless steel or ceramic materials. As these tools are scraped over the tight muscle, or unhealthy tissue, the metal or ceramic vibrates. There is no analogous vibration when the tools are scraped over healthy tissue. In this manner, the tool acts not only as an instrument for treating dysfunctional tissue, it also acts as a diagnostic tool.

One common feature among these instruments is that they include only a single, sharp and narrow contact edge. The narrow contact edge tapers down into an essentially sharp, pointed edge. When pressure is applied via the tool and this edge is scraped over tissue, a patient may experience pain or discomfort. Another feature of these instruments is that they are intended to be used solely to treat tissue after an injury has already occurred, and not for preventative tissue therapy.

Accordingly, a preventive and/or therapeutic massage device having a fine contact edge and a pressure dispersing edge to provide alternative modes of stretching to the body tissue of a user is disclosed that avoids the problems of known massage tools.

### SUMMARY

A massage device in accordance with the present disclosure may be used as a preventive and/or therapeutic device to reduce the occurrence of tight muscles and tendons, or to relieve the symptoms associated with tight muscles.

The massage device includes a main body portion having first and second opposed surfaces defined between lower and upper portions and first and second ends. A fine contact edge is formed along the lower portion of the main body. An upper handle portion is formed between the first and second opposed surfaces along the upper portion of the main body. In an exemplary embodiment, the upper handle portion can form a bulbous portion that extends away from, and has a greater width than, the first and second opposed surfaces at the upper portion of the main body. A first pressure dispersing edge extends from the first opposed surface. In particular exemplary embodiments, the pressure dispersing edge can extend from the first opposed surface at an angle between 1 and 90 degrees.

The massage device includes first and second handles which extend from the first and second ends of the main body. In a variation, the first and second handles may extend from the first and second ends of the upper handle.

In addition to the lower fine contact edge, a first handle fine contact edge having a first length is defined along an end of the first handle and a second handle fine contact edge having a second length is defined along an end of the second handle. In an exemplary embodiment, the first length is longer than the second length and the first and second handle fine contact edges are arranged to apply materials, such as moisturizer, lubricant, and ointments to a skin surface.

In a further variation, first and second enhanced grip portions are provided along the first handle and third and fourth enhanced grip portions are provided along the second handle. The enhanced grip may be provided by adding texture to the surfaces of the handles, either in the material of the handles themselves or with additional, coating materials.

In a further variation, similar texturing can be provided along the upper handle portion.

Additionally, raised indicia can be provided on the opposed surfaces to create gripping surfaces to aid with holding the massage device and/or to provide suitable information to a user, such as sales or marketing information, or instructional information on the use of the device.

In a further alternate embodiment, the fine contact edge and the first pressure dispersing edge are formed as a bifurcated extension of the second and first opposed surfaces, respectively.

In further variations, more than one pressure dispersing edge may be utilized. For example, a first and second pressure dispersing edge can extend from the first opposed surface. Alternatively, first, second, and third pressure dispersing edges can extend form the first opposed surface. Of course, any suitable number of pressure dispersing edges may be utilized.

In still a further variation, a pressure dispersing bumper can be positioned on one or both of the first and second end handles of the massage device. Additionally, a contact edge of one of the first or second end handles can be rounded or curved.

In a particular exemplary method for using a preventative and/or therapeutic massage device to stretch body tissue, a massage device is provided having any of the suitable features described above. Either the fine contact edge, or both the fine contact edge and the pressure dispersing edge are arranged at an angle along, and in contact with, a portion of body tissue. Pressure is applied through the main body portion to a portion of body tissue and the fine contact edge is slid or scraped along a portion of body tissue to provide a first stretch of the body tissue having a first magnitude, or the fine contact edge and the pressure dispersing edge are slid or scraped along a portion of body tissue to provide a second stretch of the body tissue having a second magnitude, lesser than the first magnitude.

In an exemplary method, the fine contact edge or both the fine contact edge and the pressure dispersing edge are arranged along and in contact with a portion of body tissue at approximately a 45 degree angle.

In another exemplary method, the first or second stretches are performed to treat carpal tunnel syndrome symptoms.

In a further exemplary method, the massage device includes first and second handles that extend from the first and second ends of the main body and have respective first and second fine contact edges. The first or second fine contact edges can be arranged in contact along a portion of body tissue. The first and second fine contact edges can be slid along a portion of body tissue to apply a moisturizer thereto, or to stretch the portion of body tissue.

The numerous other advantages, features and functions of embodiments of a preventative and/or therapeutic massage device with a pressure dispersing edge will become readily apparent and better understood in view of the following description and accompanying drawings. The following description is not intended to limit the scope of the massage device, but instead merely provides exemplary embodiments for ease of understanding.

### BRIEF DESCRIPTION OF THE DRAWINGS

These and other features, aspects, and advantages of the present invention will become better understood with regard to the following description, appended claims, and accompanying drawings where:

FIG. 1 is a perspective view of a first embodiment of a massage device;

FIG. 2 is a front plan view of the massage device shown in FIG. 1;

FIG. 3 is a rear plan view of the massage device shown in FIG. 1;

FIG. 4 is a top-down view of the massage device shown in FIG. 1;

FIGS. 5-7 are end views of the massage device shown in FIG. 1;

FIG. 8 is a front plan view of another embodiment of a massage device;

FIG. 9 is a rear plan view of the massage device shown in FIG. 8;

FIG. 10 is a top-down view of the massage device shown in FIG. 8;

FIG. 11 is a front plan view of another embodiment of a massage device;

FIG. 12 is an end view of the massage device shown in FIG. 11;

FIG. 13 is a front plan view of another embodiment of a massage device;

FIG. 14 is an end view of the massage device shown in FIG. 13;

FIG. 15 is rear plan view of another embodiment of a massage device;

FIG. 16 is a top-down view of the massage device shown in FIG. 15;

FIGS. 17-18 each represent an end view of variations of a massage device;

FIG. 20 is a front plan view of another embodiment of a massage device;

FIG. 21 is a top-down view of the massage device shown in FIG. 20;

FIG. 22 is a rear plan view of the massage device shown in FIG. 20 shown in an exemplary manner of use;

FIG. 23 is a rear plan view of another embodiment of a massage device;

FIG. 24 is a front plan view of another embodiment of a massage device;

FIG. 25 is a top-down view of the massage device shown in FIG. 24.

It should be noted that the drawing figures are not necessarily drawn to scale, but instead are drawn to provide a better understanding of the components thereof, and are not intended to be limiting in scope, but rather to provide exemplary illustrations. It should further be noted that the figures illustrate exemplary embodiments and use of a massage device and the components thereof, and in no way limit the structures or configurations of a massage device and components thereof according to the present disclosure.

### DETAILED DESCRIPTION

### A. Environment and Context of the Various Embodiments

Different embodiments of a massage device are described herein in the context of providing preventative and/or therapeutic treatment to body tissues such as skin, muscle, fascia, and tendons. The massage devices can easily be used, by both practitioners and patients themselves, in order to apply either a deep, penetrating stretch, or a less intense, gentler stretch. The gentler stretch may be used to treat acute injuries or for persons having lower pain tolerance thresholds. The massage devices can be utilized to massage any part of the user's body, for example, feet, hands, arms, legs, back, shoulders, and chest.

The stretches are performed by applying pressure to the body tissue through the massage device, and sliding or scraping the massage device along the body tissue. The deeper and gentler stretches may be performed daily, or prior to competitive games or practices, as part of a preventative regimen to avoid tissue injury. The stretches may also be performed as a therapeutic treatment for injured tissue.

Accordingly, embodiments and variations of a preventative and/or therapeutic massage device for providing a deep stretch and/or a gentle stretch are described below.

### B. Description of a Whole Body Massage Device

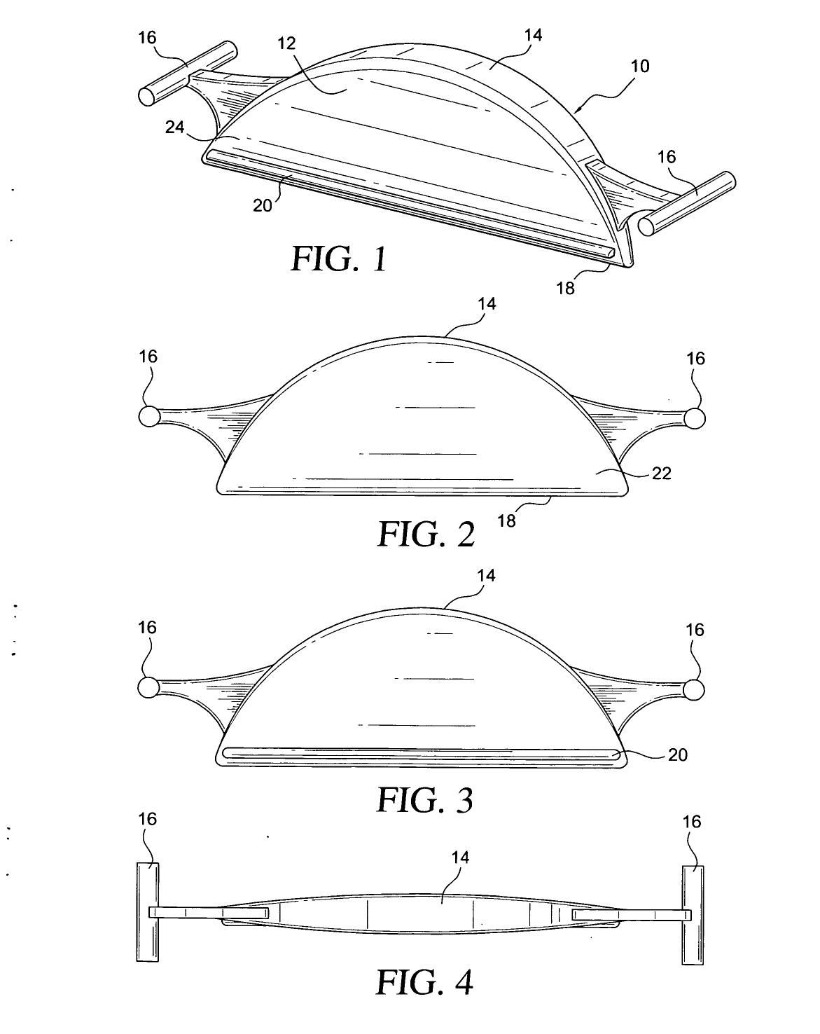

A first embodiment of a preventative and/or therapeutic massage device 10 is shown in FIGS. 1-7. The massage device 10 includes a main body 12 which may be formed from any suitable material. Exemplary materials include, but are not limited to, metals, such as aluminum, titanium, and stainless steel, plastics, such as polymers, resins, polyethylene, and polyvinylchloride, ceramics, and glass and/or carbon fiber epoxy composites. The massage device 10 may be formed in any suitable manner, such as by forging, casting, machining, injection molding, layering, or any other appropriate process.

When materials having good thermal conductivity are used, additional therapeutic treatment may be achieved by applying temperature differentials to the body tissue to be treated by heating or cooling the massage device prior to use.

In this exemplary embodiment, the main body 12 has a generally elongated, half ellipsoid shape. The main body 12 has upper and lower portions and first and second ends. The main body 12 further defines first and second opposed surfaces 24, 22. The first opposed surface 24 defines the gentler stretch side and the second opposed surface 22 defines the deeper stretch side, as will be discussed in more detail below.

The massage device 10 includes three handle portions. An upper handle portion, or top handle, 14 is formed at the upper portion of the main body 12. The top handle may have any suitable shape and is disclosed as having an arcuate shape extending along the upper portion of the main body 12. Edges of the upper handle 14 can extend generally perpendicularly away from the opposed surfaces 22, 24 of the main body 12.

End handles 16 are formed extending from the first and second ends of the main body 12. The end handles 16 may have any suitable shape, and are disclosed as generally cylindrically shaped handles oriented to extend generally perpendicularly to the opposed surfaces 22, 24 of main body 12 of the massage device 10. A user may utilize any one or two of the three handles to manipulate the massage device 10.

The opposed surfaces 22, 24 of the main body 10 are slightly angled towards each other, such that the opposed surfaces come together at the lower end of the main body 10 to define a fine contact edge 18. The edge may be generally rounded off or tapered, so as not to be so sharp as to cause cutting or slicing injuries to the body tissue.

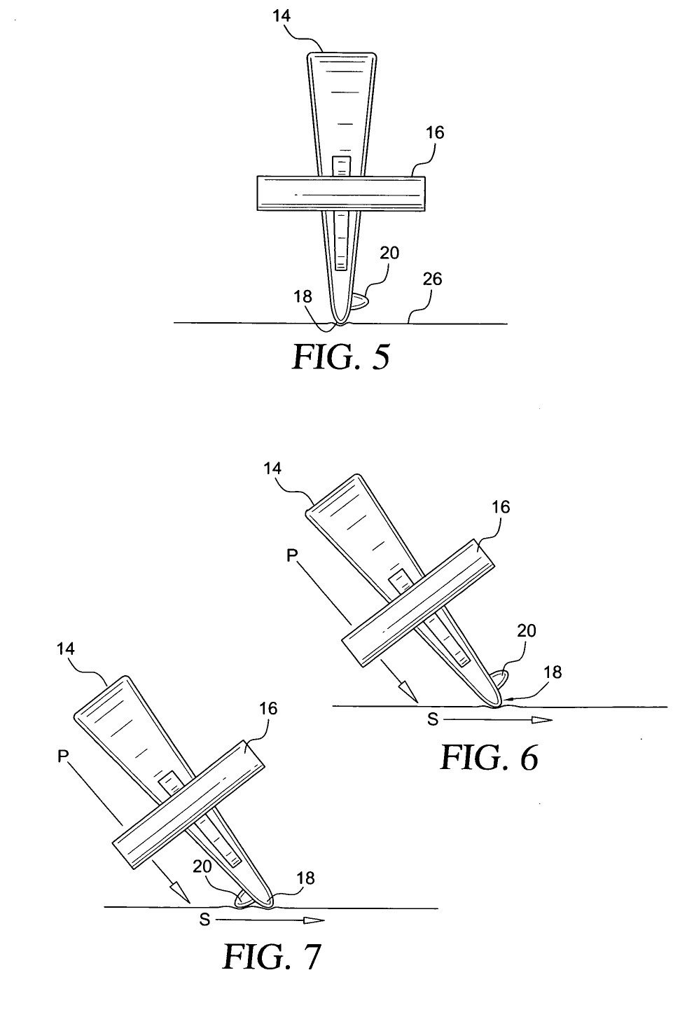

As shown in FIGS. 5 and 6, the fine contact edge 18 can be scraped over body tissue to provide a deep, penetrating stretch. This is accomplished by first applying a moisturizer, such as shea butter, lubricant, ointments, or other suitable material to the skin 26 in the area of the body tissue to be treated. The fine contact edge 18 of the massage device 10 is then placed in contact with the skin 26 of a portion of the body. The massage device 10 can be positioned at an angle (any suitable angle between 1 and 90 degrees may be used, 45 degrees is illustrated) to the body tissue and a pressure P is applied through the massage device 10 to the body tissue. Next, the massage device 10 is slid or scraped over the body tissue in the stretching direction S. This process is repeated over the same area of body tissue for a number of minutes until the desired amount stretching is achieved.

Due to the shape of the fine contact edge 18, a deep, penetrating stretch of the body tissue, such as skin 26, muscles, fascia, and/or tendons is achieved. The shape of the fine contact edge 18 intensifies and focuses the force applied to the massage device 10 into a deep, penetrating stretch. This stretch can be used as a preventative measure to avoid injuries to the body tissue.

As shown in FIG. 3, as an alternative, or to treat injuries to the body tissue, a pressure dispersing edge or bumper 20 is formed along, and extending approximately perpendicularly from, the first opposed surface 24 near the lower end thereof. As illustrated, the pressure dispersing bumper 20 is formed along substantially the entire length of the massage device 10. It will be recognized that the pressure dispersing edge 20 may also be formed along only a portion of the first opposed side 24, or in segments along the first opposed side 24, or in any other suitable configuration. The profile of the pressure dispersing edge 20 may be any suitable shape in order to provide the necessary stretching, while also dispersing pressure to provide a less penetrating stretch.

As shown in FIG. 7, a less aggressive, gentler stretch can be achieved by utilizing the fine contact edge 18 in combination with the pressure dispersing edge 20. The stretch is performed in a similar manner as discussed above, with the exception that both the fine contact edge 18 and the pressure dispersing edge 20 are placed in contact with the skin 26. Also, when the massage device 10 is used to treat injured body tissue, additional moisturizer and/or lubricant, such as shea butter may be used. Again, a pressure P is applied to the body tissue through the massage device 10, via both the fine contact edge 18 and the pressure dispersing edge 20, and the massage device is slid or scraped along the skin 26 in the stretching direction S.

Since the pressure P applied through the massage device 10 is divided between the fine contact edge 18 and the pressure dispersing edge 20, a less aggressive, gentler stretch of the body tissues is achieved. This type of stretch is beneficial to use with persons having low pain thresholds, or in order to provide therapeutic treatment to body tissues with acute injuries. Again, the process is repeated for several minutes over the same area of tissue in order to achieve the desired results.

The processes discussed above can be used to treat the tissue of any suitable part of the body, for example the thigh, gluteal, hamstring, and leg muscles. Additionally, the muscles located above and below the knee may also be treated. Further, the arms, forearms, pectorals, chest, and neck can be treated using the processes discussed above.

The massage device 10 can be used in combination with traditional stretching protocols to enhance such protocols for preventing and treating injuries to body tissue. The use of the massage device 10 on soft tissue, in particular around a joint of the body, will stretch the soft tissue and allow the joint to become more loose and flexible.

In order to aid with self use of the massage device 10, a fully detailed instruction manual may be provided therewith with explanations of use of the massage device 10 for self stretching and massage. A kit may also be provided that can include a carrying pouch, the massage device 10, an instructional video (any suitable format), and moisturizer and/or lubricant, such as shea butter.

While the above description of the massage device 10 provides an exemplary configuration of a massage device having a pressure dispersing edge, additional embodiments, configurations, and variations are described below.

### C. Description of a Carpal Tunnel Massage Device

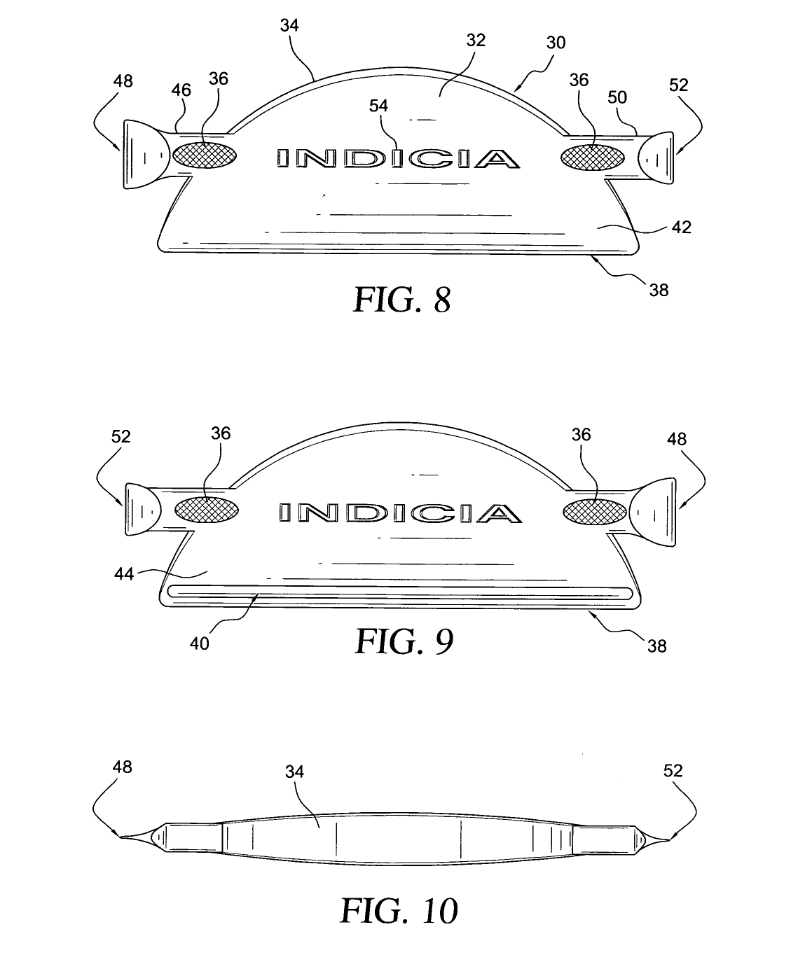

While the massage device 10 discussed above may be utilized on any part of the body, the massage device 30 shown in FIGS. 8-10 is particularly arranged for use in the treatment of carpal tunnel injuries, pain, and symptoms. Of course, it will be recognized that the massage device 30 can also be used to treat any body part or tissue.

The massage device 30 resembles the massage device 10 discussed above. Therefore, a detailed explanation of features previously discussed is not provided. The massage device 30 may have a generally similar shape to the massage device 10, including a main body 32, an upper handle 34, and first and second opposed sides 44, 42. Like the massage device 10, a fine contact edge 38 and a pressure dispersing edge 40 are provided along the lower portion of the massage device 30, the use of which is discussed above in detail.

Since the massage device 30 is designed to treat carpal tunnel symptoms/injuries, the overall size of the device may be smaller, as would be appropriate to massaging the wrist, hand, and finger joints.

The first and second end handles 46, 50 have longitudinal portions extending from the main body portion 32 in a substantially parallel manner with respect to the fine contact edge 38. The first and second end handles 46, 50 have first and second contact edges 48, 52 respectively formed thereon, and perpendicularly to the longitudinal portions thereof. The first contact edge 48 can be longer than the second contact edge 52 to provide contact edges appropriate for use with differing areas of the body.

For example, the second contact edge 52 may be used, in a manner described above, to provide a deep penetrating stretch to the body tissues around, and between the fingers of the hand, while the first contact edge 48 can be used on the body tissues around the palm and the back of the hand.

The first and second contact edges 48, 52 can also be used as applicators to apply lubricants, ointments, and moisturizers, such as shea butter. A small amount of material can be placed upon the contact edge, which may then be drawn across the skin to apply the material.

Since the massage device 30 will be generally smaller in shape, it may be more difficult to maintain an appropriate grip. Additionally, the use of lubricants, ointments, and moisturizers, such as shea butter, may make the smooth surfaces of the massage device 30 difficult to grip. Accordingly, enhanced gripping portions 36 utilizing a texture feature can be provided.

The enhanced grip portions can be positioned in any suitable location on the main body portion 32, or on opposed first and second end handles 46, 50. The enhanced grip portions 36 can be provided on both of the surfaces of each of the first and second end handles 46, 50, corresponding to the opposed surfaces 42, 44 of the main body portion 32. The texture feature of the enhanced grip may be formed in any suitable manner, such as by applying a friction tape or other coating to the surfaces, providing integral texture on the surfaces, providing dimples or drilled holes in the surfaces, or any other appropriate structure.

In addition to the grip portions 36, indicia 54 can be provided on the opposed surfaces 42, 44 of the main body 32 below or near the upper handle 34 in order to provide information to a user and/or to enhance the gripping of the opposed surfaces 42, 44. Such indicia 54 may be printed or painted directly on the opposed surfaces 42, 44. Alternatively, the indicia 54 may be a printed label attached to the opposed surfaces 42, 44 via a suitable adhesive. The indicia 54 may also be raised or depressed lettering integrally formed with the main body portion 32. While the indicia 54 is exemplarily shown as lettering, it will be recognized that the indicia may be numbers, letters, any graphical illustration, or any other design It will also be recognized that the enhanced grip features and indicia of the massage device 30 can also be provided to the massage device 10.

The massage device 30 is used in the same manner as discussed above with respect to massage device 10 in order to treat the symptoms of carpal tunnel syndrome, such as pain and numbness of the hand and fingers. Further, the fine contact edge 38 and the pressure dispersing edge 40 can be used to stretch the tissues in the wrist, forearm, and arm. Further, while massage device 30 is designed to treat carpal tunnel syndrome symptoms, it can also be used to stretch the tissues of any other part of the body as well.

Variations of the carpal tunnel massage device are discussed next.

### D. Description of a Variation of a Carpal Tunnel Massage Device

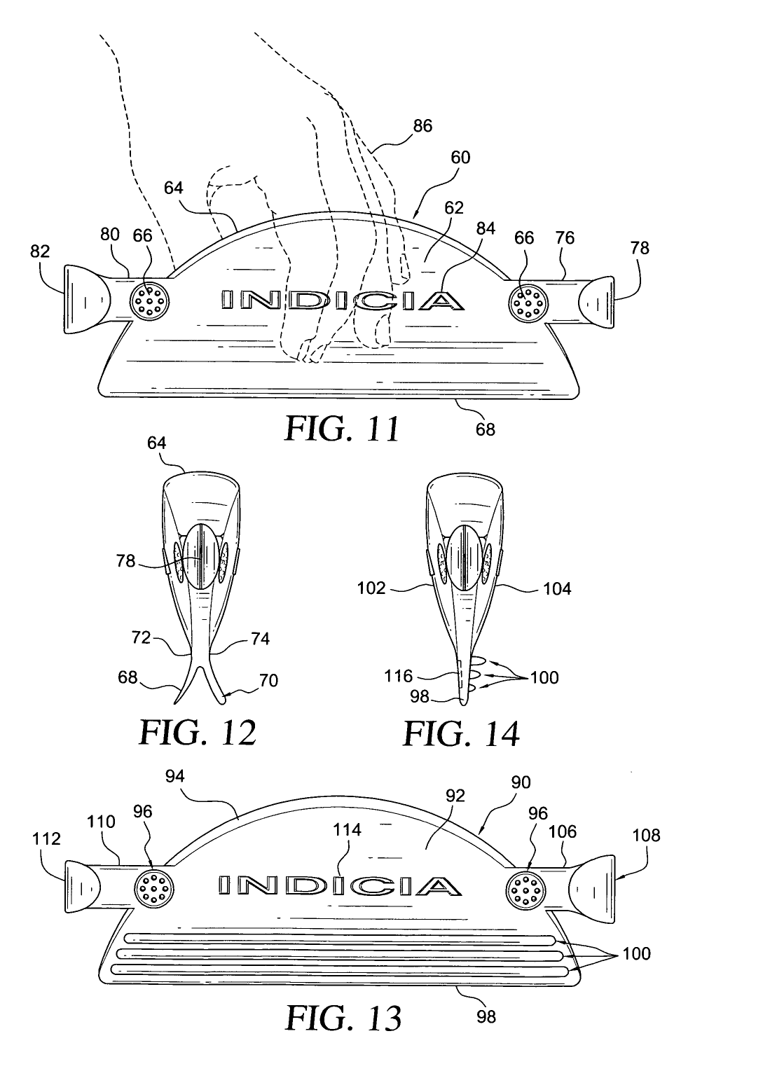

A variation of a carpal tunnel massage device 60 is shown in FIGS. 11 and 12. Of course, the variations described herein can also be applied to the whole body massage device. The massage device 60 is comparable in form and function to those previously discussed and includes a main body portion 62 with upper and lower portions, and first and second ends. An upper handle 64 is positioned along the upper portion and first and second end handles 76, 80 are positioned at the respective ends. The first end handle 76 has a larger first contact edge 78, and the second end handle 80 has a smaller second contact edge 82. Enhanced grip portions 66 can be provided on each of the first and second end handles 76, 80.

As in previous embodiments, the main body portion 64 has first and second opposed sides 74, 72. The first and second opposed sides 74, 72 can include indicia 84 to engage the fingers 86 of the user to enhance the user's grip and/or to provide information.

As shown in FIG. 12, the lower portion of the main body 62 is bifurcated to form the fine contact edge 68 and the pressure dispersing edge 70. The fine contract edge 68 extends from the second opposed side 72 and is formed in an elongated, narrow, pointed shape in order to provide a deeper penetrating stretch. The pressure dispersing edge 70 extends from the first opposed side 74 and is formed with a wider, more blunted shape in order to provide a gentler, less aggressive stretch.

The use of the fine contact edge 68 and the pressure dispersing edge 70 to provide the two different types of stretching is the same as described above with respect to massage device 10.

Another variation of a carpal tunnel massage device is discussed next.

### E. Description of a Second Variation of a Carpal Tunnel Massage Device

A second variation of a carpal tunnel massage device 90 is shown in FIGS. 13 and 14. This variation is like the massage device 30, and includes a main body portion 92 with upper and lower portions and first and second ends. An upper handle 94 is formed at the upper portion and first and second end handles 106, 110 are formed extending from the first and second ends. The first end handle 106 has a larger first contact edge 108, and the second end handle 110 has a smaller second contact edge 112. Enhanced grip portions 96 can be provided on each of the first and second end handles 106, 110.

Like previous embodiments, the main body portion 92 has first and second opposed sides 104, 102. The first and second opposed sides 104, 102 can include indicia 114 to engage the fingers of the user to enhance the user's grip and to provide information.

A fine contact edge 98 is formed at the lower portion between the first and second opposed sides 104, 102. The use of the fine contact edge 98 is the same as described above in detail.

In a variation from previous embodiments, a magnetic strip of material 116 may be embedded near the lower portion along the second opposed surface 102. Such a magnetic strip can provide therapeutic effects by altering the magnetic fields of the tissue as the massage device 90 is scraped or slid along the body tissue. While an embedded magnetic strip is disclosed, it will be recognized than any suitable configuration may be used. For example, a magnetic strip attached to the surface, or a number of magnetic segments embedded or attached to the surface in a spaced apart manner may be used.

In a further variation, more than one pressure dispersing edges 100 extend from the first opposed side 104. The use of the pressure dispersing edges is the same as described above with respect to massage device 10. The difference being that the three disclosed pressure dispersing edges each increase in height or extension from the lower edge toward the upper portion. Thus, the edges 100 will act in the following manner, when stretching the body tissue, the tissue that is not caught by the shortest edge, will be caught by the second or the tallest edge, such that all of the body tissue will be appropriately stretched, in the gentler manner previously discussed.

It will be recognized that more than or less than three pressure dispersing edges may be utilized.

Another variation of a carpal tunnel massage device is discussed next.

### F. Description of a Third Variation of a Carpal Tunnel Massage Device

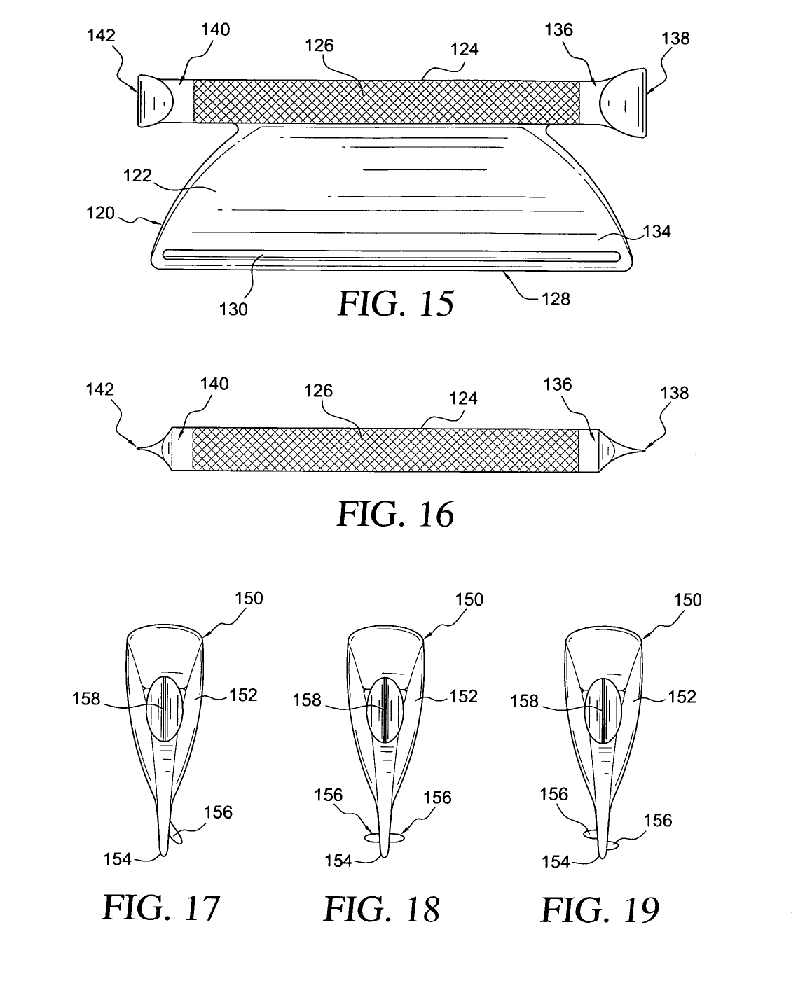

A third variation of a carpal tunnel massage device 120 is shown in FIGS. 15 and 16. This variation is similar to the massage device 30, and includes a main body portion 122 having a broad blade-like shape, like a putty knife, with upper and lower portions and first and second ends. An upper handle 124 is formed at the upper portion and first and second end handles 136, 140 are formed extending from the first and second ends. Enhanced grip portion 126 is formed on the upper handle 124, which may be somewhat cylindrical in shape. The first end handle 136 has a larger first contact edge 138, and the second end handle 140 has a smaller second contact edge 142.

As with previous embodiments, the main body portion 122 has first 134 and second opposed sides. A fine contact edge 128 is formed at the lower portion between the first and second opposed sides. The use of the fine contact edge 128 is the same as described above in detail.

Again, similarly to previously discussed embodiments, a pressure dispersing edge 130 extends from the first opposed side 134 and functions in a manner as described above.

The larger upper handle portion 124 and the enhanced gripping portion 126 thereon increase the ability of the user to manipulate the massage device 120.

Next, variations of pressure dispersing edges are discussed.

### G. Variations of Pressure Dispersing Edges

Three variations of pressure dispersing edges are shown in FIGS. 17-19.

As shown in FIG. 17, the massage device 150 has a main body portion 152 with end handles having a contact edges 158 in a manner previously discussed. As also previously discussed, a fine contact edge 154 is formed between first and second opposed side surfaces.

In the variation shown in FIG. 17, the pressure dispersing edge 156 extends away from the first opposed side at a downward angle, as opposed to perpendicularly as previously discussed. The angle can be any angle between 1 and 90 degrees, and is shown at an approximately 45 degree angle in FIG. 17. The variation of this angle may be used to alter the effects of the pressure dispersing edge 156.

In another variation, as shown in FIG. 18, a pressure dispersing edge 156 extends substantially perpendicularly from each of the first and second opposed sides of the main body. Thus, the massage device 150 can be used in back and forth motion to apply a gentler stretch to the body tissue, without having to remove the massage device 150 from contact with the body tissue.

In a still further variation, a pressure dispersing edge 156 extends substantially perpendicularly from each of the first and second opposed sides of the main body in an offset manner. Thus, in addition to allowing the back and forth massage motion just discussed, the magnitude of the gentle stretch can be varied from one direction to the other.

While these variations are described in the context of a carpal tunnel massage device, it will be recognized that they are equally applicable to a whole body massage device.

Next, a further embodiment of a carpal tunnel massage device is described.

### H. Description of a Fourth Variation of a Carpal Tunnel Massage Device

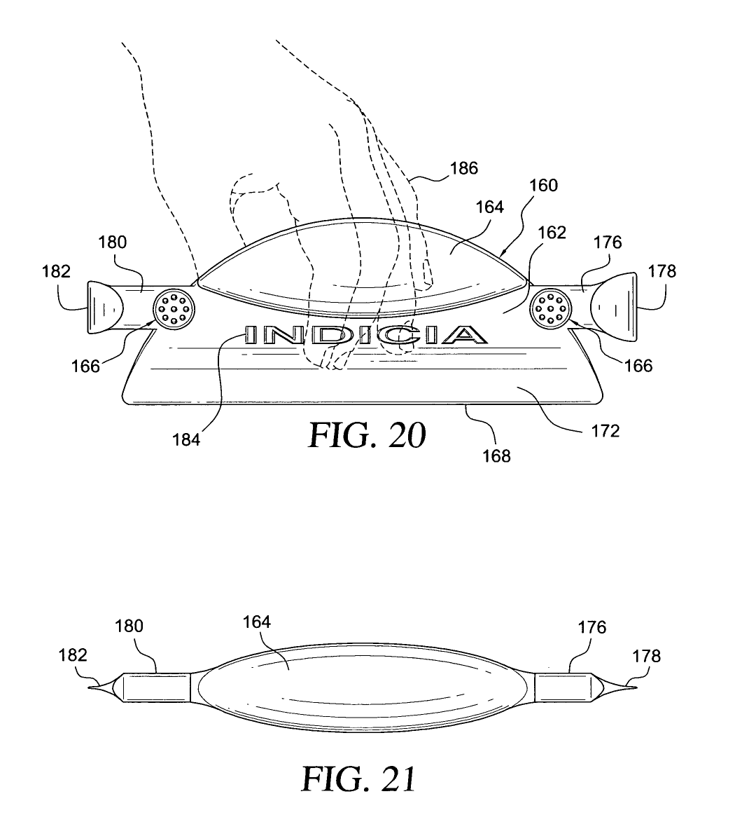

A fourth variation of a carpal tunnel massage device 160 is shown in FIGS. 20-22. This variation resembles the massage device 30, and includes a main body portion 162 with upper and lower portions and first and second ends. An upper handle 164 is formed at the upper portion. The upper handle 164 is formed as a bulbous portion having an enlarged width for enhanced comfort and fit for the user's hand 186.

First and second end handles 176, 180 are formed extending from the first and second ends. The first end handle 176 has a larger first contact edge 178, and the second end handle 180 has a smaller second contact edge 182. Enhanced grip portions 166 can be provided on each of the first and second end handles 176, 180.

Similarly to previous embodiments, the main body portion 162 has first and second opposed sides 174, 172. The first and second opposed sides 174, 172 can include indicia 184 to engage the fingers of the user to enhance the user's grip and to provide information.

A fine contact edge 168 is formed at the lower portion between the first and second opposed sides 174, 172. The use of the fine contact edge 168 is the same as described above in detail. The first and second opposed sides 174, 172 define a narrow width at the formation of the fine contact edge 168 and may define a slightly larger width at the upper portion thereof.

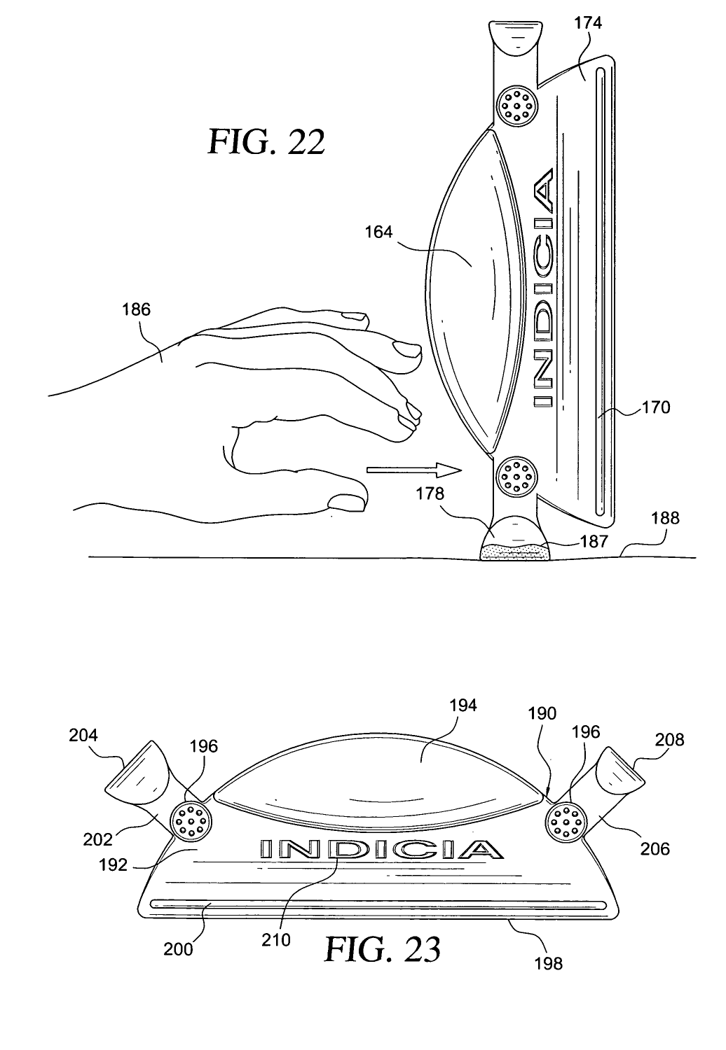

As shown in FIG. 22, a pressure dispersing edge 170 of the type previously described is positioned along the lower portion of the first opposed side 174 for use in the manner as detailed above.

In order to enhance the gripping function provided by the upper handle 164, the width of the bulbous upper handle 164 is larger than the width defined between the first and second opposed sides 174, 172 so that the palm of the hand 186 can rest upon the bulbous portion while the fingers wrap around the bulbous portion.

An illustration of the use of an end contact edge to apply material is shown in FIG. 22. Material 187, such as moisturizer, lubricant, or ointment is spread over the firs end handle contact edge 178. This edge is brought into contact with the skin 188 and the user grips the first handle 176 with their hand 186 to spread the material 187 along the skin 188. Thus, friction between the massage device and the skin can be reduced, and therapeutic benefits of the material can be spread over a large area.

Next, a further embodiment of a carpal tunnel massage device is described.

### I. Description of a Fifth Variation of a Carpal Tunnel Massage Device

A fifth variation of a carpal tunnel massage device 190 is shown in FIG. 23. This variation is comparable to the massage device 30, and includes a main body portion 192 with upper and lower portions and first and second ends. An upper handle 194 is formed at the upper portion and first and second end handles 202, 206 are formed extending from the first and second ends. The first end handle 202 has a larger first contact edge 204, and the second end handle 206 has a smaller second contact edge 208. Enhanced grip portions 196 can be provided on each of the first and second end handles 202, 206.

As with previous embodiments, the main body portion 192 has first and second opposed sides that can include indicia 210 to engage the fingers of the user to enhance the user's grip and to provide information.

A fine contact edge 198 is formed at the lower portion between the first and second opposed sides. The use of the fine contact edge 198 is the same as described above in detail. A pressure dispersing edge 200 of the type discussed above is positioned along the lower portion of the first opposed side for use in the manner as previously explained.

With regard to the first and second end handles 202, 206, instead of extending in a substantially parallel manner to the fine contact edge 198, they can be shifted along the perimeter of the main body portion 192 so that they extend off at an angle with respect to the fine contact edge 198. The angle may be any desired angle, and is shown as an approximately 45 degree angle.

In this manner, the comfort and fit of the end handles 202, 206 may be modified to accommodate different users or stretches.

A further variation of a carpal tunnel massage device is described below.

### J. Description of a Sixth Variation of a Carpal Tunnel Massage Device

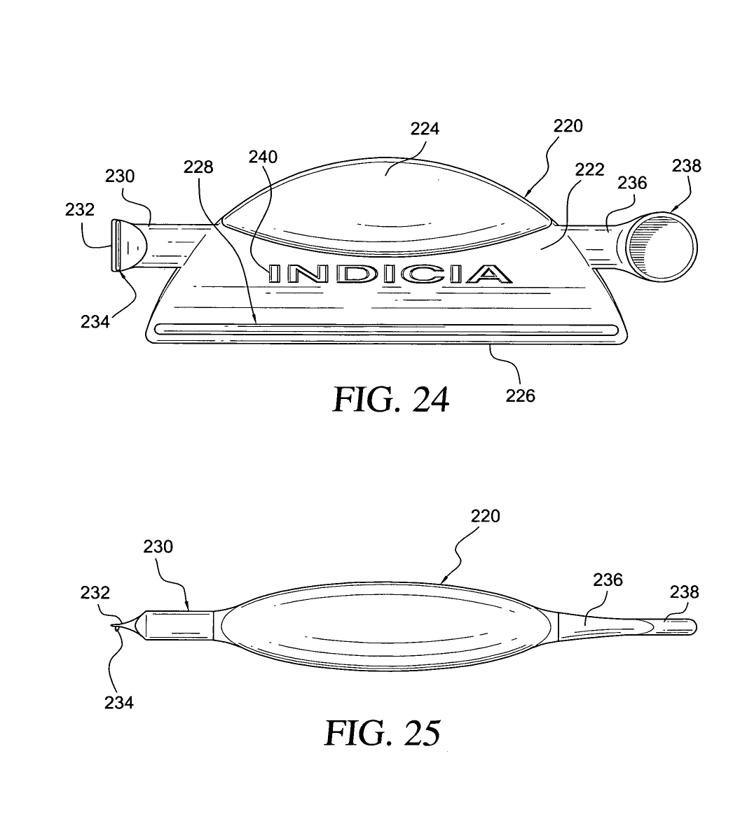

A fifth variation of a carpal tunnel massage device 220 is shown in FIGS. 24 and 25. This variation is similar to the massage device 160, and includes a main body portion 222 with upper and lower portions and first and second ends. An upper handle 224 is formed at the upper portion and first and second end handles 230, 236 are formed extending from the first and second ends. The first end handle 230 has a straight, fine contact edge 232, and the second end handle 236 has a curved or rounded contact edge 238. The straight, fine contact edge 232 functions as previously described. The rounded or curved contact edge 238 allows a user to provide an even deeper and penetrating massage than can be obtained by the use of a straight contact edge.

In addition to the fine contact edge 232, the first end handle 230 also includes a pressure dispersing edge 234 along at least one side thereof, as shown in FIGS. 24 and 25. This pressure dispersing edge 234 functions in a manner previously described in detail, and no further discussion is necessary. The pressure dispersing edge 234 allows a user to provide a more relaxed stretch to smaller areas that may not be reached with a larger edge

Like previous embodiments, the main body portion 222 has first and second opposed sides that can include indicia 240 to engage the fingers of the user to enhance the user's grip and to provide information.

A fine contact edge 226 is formed at the lower portion between the first and second opposed sides. The use of the fine contact edge 226 is the same as described above in detail. A main pressure dispersing edge 228 of the type previously described is positioned along the lower portion of the first opposed side for use in the manner as previously discussed.

With the construction of this embodiment, harder to reach areas, such as between knuckles and fingers, can utilize the benefits of the more relaxed stretch that can be provided by the use of a pressure dispersing edge 234 along a handle. Further, an even deeper stretch can be provided to the harder to reach areas by use of the rounded or curved edge 238 of the second handle 236.

### K. Conclusion

The disclosed embodiments of a massage device are particularly useful for providing preventative and therapeutic treatment to body tissues via stretching of the body tissues. Specifically, both a deep stretch and a gentle stretch can be applied using the massage devices disclosed herein.

It is understood that the size of the massage device and the components thereof can be adjusted to accommodate different sizes of body tissues or persons.

Of course, it is to be understood that not necessarily all objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

The skilled artisan will recognize the interchangeability of various features from different embodiments. In particular, the structures described with respect to the various carpal tunnel massage devices can also be used with the whole body massage device. Further, it will be recognized that each fine contact edge disclosed herein may be accompanied by a pressure dispersing edge as disclosed herein. Thus, the contact edges of the end handles disclosed herein may also include pressure dispersing bumpers.

In addition to the variations described herein, other known equivalents for each feature can be mixed and matched by one of ordinary skill in this art to construct a massage device in accordance with principles of the present invention.

Although this invention has been disclosed in the context of certain exemplary embodiments and examples, it therefore will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above.

I claim:

1. A preventive and/or therapeutic massage device comprising:
a main body portion having first and second opposed surfaces defined between lower and upper portions and first and second ends;
a fine contact edge formed along the lower portion of the main body;
a upper handle portion formed between the first and second opposed surfaces along the upper portion of the main body; and
a first pressure dispersing edge extending from the first opposed surface.

2. The preventive and/or therapeutic massage device according to claim 1, further comprising:
a first handle extending from the first end of the main body; and.
a second handle extending from the second end of the main body.

3. The preventive and/or therapeutic massage device according to claim 2, further comprising:
a handle fine contact edge defined along an end of the second handle; and
a handle pressure dispersing edge extending from a surface of the second handle.

4. The preventive and/or therapeutic massage device according to claim 2, further comprising:
a first handle fine contact edge defined along an end of the first handle; and
a second handle fine contact edge defined along an end of the second handle.

5. The preventive and/or therapeutic massage device according to claim 4, wherein the first handle fine contact edge has a first length larger than a second length of the second handle fine contact edge; and
wherein the first and second handle fine contact edges are arranged to apply moisturizer to a skin surface.

6. The preventive and/or therapeutic massage device according to claim 4, further comprising:
first and second texture features located along the first handle and third and fourth texture features located along the second handle.

7. The preventive and/or therapeutic massage device according to claim 1, further comprising:
a first handle extending from a first end of the upper handle portion; and
a second handle extending from a second end of the upper handle portion.

8. The preventive and/or therapeutic massage device according to claim 7, further comprising:
a texture feature located along the upper handle portion.

9. The preventive and/or therapeutic massage device according to claim 1, further comprising:
raised indicia positioned along the first and second opposed surfaces to provide information and/or an enhanced grip.

10. The preventive and/or therapeutic massage device according to claim 1, wherein the fine contact edge and the first pressure dispersing edge are formed as a bifurcated extension of the second and first opposed surfaces, respectively.

11. The preventive and/or therapeutic massage device according to claim 1, wherein the first pressure dispersing edge extends from the first opposed surface at an angle between 1 and 90 degrees.

12. The preventive and/or therapeutic massage device according to claim 1, further comprising:
a second pressure dispersing edge extending from the second opposed surface.

13. The preventive and/or therapeutic massage device according to claim 1, further comprising:
second and third pressure dispersing edges extending from the first opposed surface.

14. The preventive and/or therapeutic massage device according to claim 1, wherein the upper handle portion forms a bulbous portion that extends away from, and has a greater width than, the first and second opposed surfaces at the upper portion of the main body.

15. A method of using a preventive and/or therapeutic massage device to stretch body tissue, the method comprising:
providing a massage device having;
a main body portion having first and second opposed surfaces defined between lower and upper portions and first and second ends;
a fine contact edge formed along the lower portion of the main body;
a upper handle portion formed between the first and second opposed surfaces along the upper portion of the main body; and
a first pressure dispersing edge extending from the first opposed surface.
arranging either the fine contact edge, or both the fine contact edge and the pressure dispersing edge at an angle along, and in contact with, a portion of body tissue;
applying pressure through the main body portion to a portion of body tissue; and
sliding the fine contact edge along a portion of body tissue to provide a first stretch of the body tissue having a first magnitude; or
sliding the fine contact edge and the pressure dispersing edge along a portion of body tissue to provide a second stretch of the body tissue having a second magnitude, lesser than the first magnitude.

16. The method according to claim 15, further comprising:
arranging either the fine contact edge, or both the fine contact edge and the pressure dispersing edge at an approximately 45 degree angle along, and in contact with, a portion of body tissue.

17. The method according to claim 15, further comprising:
performing the first or second stretch to treat carpal tunnel syndrome symptoms.

18. The method according to claim 15, further comprising:
providing the massage device with first and second handles, having respective first and second fine contact edges, extending from the first and second ends of the main body, respectively; and
arranging either the first or second fine contact edge along a portion of body tissue.

19. The method according to claim 18, further comprising:
sliding either the first or second fine contact edge along a portion of body tissue to apply a moisturizer thereto.

20. The method according to claim 18, further comprising:
sliding either the first or second fine contact edge along a portion of body tissue to stretch the body tissue.
